(19) United States
(12) Patent Application Publication
(10) Pub. No.: US 2018/0005015 A1
(43) Pub. Date: Jan. 4, 2018

(54) SPARSE SIMULTANEOUS LOCALIZATION AND MATCHING WITH UNIFIED TRACKING

(71) Applicant: VanGogh Imaging, Inc., McLean, VA (US)

(72) Inventors: Xin Hou, Herndon, VA (US); Craig Cambias, Silver Spring, MD (US)

(21) Appl. No.: 15/638,278

(22) Filed: Jun. 29, 2017

Related U.S. Application Data
(60) Provisional application No. 62/357,916, filed on Jul. 1, 2016.

(51) Int. Cl. G06K 9/00; G01S 17/06; G01S 17/02; G01S 13/86; G06K 9/62; G01S 13/06

(52) U.S. Cl. CPC G06K 9/00201; G06K 9/6255; G06K 9/00664; G01S 13/06; G01S 17/02; G01S 13/86; G01S 17/06

(57) ABSTRACT

Described herein are methods and systems for tracking a pose of one or more objects represented in a scene. A sensor captures a plurality of scans of objects in a scene, each scan comprising a color and depth frame. A computing device receives a first one of the scans, determines two-dimensional feature points of the objects using the color and depth frame, and retrieves a key frame from a database that stores key frames of the objects in the scene, each key frame comprising map points. The computing device matches the 2D feature points with the map points, and generates a current pose of the objects in the color and depth frame using the matched 2D feature points. The computing device inserts the color and depth frame into the database as a new key frame, and tracks the pose of the objects in the scene across the scans.

### RELATED APPLICATIONS

This application claims priority to U.S. Provisional Patent Application No. 62/357,916, filed on Jul. 1, 2016, the entirety of which is incorporated herein by reference.

### TECHNICAL FIELD

The subject matter of this application relates generally to methods and apparatuses, including computer program products, for sparse simultaneous localization and matching (SLAM) with unified tracking in computer vision applications.

### BACKGROUND

Generally, traditional methods for sparse simultaneous localization and mapping (SLAM) focus on tracking the pose of a scene from the perspective of a camera or sensor that is capturing images of a scene, as well as reconstructing the scene sparsely with low accuracy. Such methods are described in G. Klein et al., “Parallel tracking and mapping for small AR workspaces,” ISMAR '07 Proceedings of the 2007 6^{th} IEEE and ACM International Symposium on Mixed and Augmented Reality, pp. 1-10 (2007) and R. Mur-Atal, ORB-SLAM: a versatile and accurate monocular SLAM system,” IEEE Transactions on Robotics (2015). Traditional methods for dense simultaneous localization and mapping (SLAM) focus on tracking the pose of sensors, as well as reconstructing the object or scene densely with high accuracy. Such methods are described in R. Newcombe et al., “KinectFusion: Real-time dense surface mapping and tracking” Mixed and Augmented Reality (ISMAR), 2011 10th IEEE International Symposium and T. Whelan et al., “Real-time Large Scale Dense RGB-D SLAM with Volumetric Fusion” International Journal of Robotics Research Special Issue on Robot Vision (2014).

Typically, such traditional dense SLAM methods are useful when analyzing an object with many shape features and few color features but do not perform as well when analyzing an object with few shape features and many color features. Also, dense SLAM methods typically require a significant amount of processing power to analyze images captured by a camera or sensor and track the pose of objects within.

### SUMMARY

Therefore, what is needed is an approach that incorporates sparse SLAM to focus on enhancing the object reconstruction capability on certain complex objects, such as symmetrical objects, and improving the speed and reliability of 3D scene reconstruction using 3D sensors and computing devices executing vision processing software.

The sparse SLAM technique described herein provide certain advantages over other, preexisting techniques:

The sparse SLAM technique can apply a machine learning procedure to train key frames in a mapping database, in order to make global tracking and loop closure more efficient and reliable. Also, the sparse SLAM technique can train features in key frames, and then more descriptive features can be acquired by projecting high-dimension untrained features to low-dimension with trained feature model.

Via its aggressive feature detection and key frame insertion processing, the 3D-sensor-based sparse SLAM technique described herein can be used as 3D reconstruction software to model objects that have few shape features but have many color features, such as a printed symmetrical object. FIG. 1 provides examples of such symmetrical objects (e.g., a cylindrical container on the left, and a rectangular box on the right).

Because depth maps from 3D sensors are generally already accurate, the sparse SLAM technique can directly reconstruct a 3D mesh using the depth maps from the camera and poses generated by the sparse SLAM technique. In some embodiments, post-processing—e.g., bundle adjustment, structure from motion, TSDF modeling, or Poisson reconstruction—is used to enhance the final result.

Also, when synchronized with a dense SLAM technique, the sparse SLAM technique described herein provides high-speed tracking capabilities (e.g., more than 100 frames per second), against an accurate reconstructed 3D mesh obtained from dense SLAM, to leverage on complex computer vision applications like augmented reality (AR).

For example, when sparse SLAM is synchronized with dense SLAM:

1) The object or scene poses obtained from a tracking module executing on a processor of a computing device that is coupled to the sensor capturing the images of the object can be used for iterative closest point (ICP) registration in dense SLAM to improve reliability.

2) The poses of key frames from a mapping module executing on the processor of the computing device are synchronized with the poses for Truncated Signed Distance Function (TSDF) in dense SLAM in order to align the mapping database of sparse SLAM with the final mesh of dense SLAM, thereby enabling high-speed object or scene tracking (of sparse SLAM) using the accurate 3D mesh (of dense SLAM).

3) The loop closure process in sparse SLAM helps dense SLAM to correct loops with few shape features but many color features.

It should be appreciated that the techniques herein can be configured such that sparse SLAM is temporarily disabled and dense SLAM by itself is used to analyze and process objects with many shape features but few color features.

The invention, in one aspect, features a system for tracking a pose of one or more objects represented in a scene. The system comprises a sensor that captures a plurality of scans of one or more objects in a scene, each scan comprising a color and depth frame. The system comprises a database that stores one or more key frames of the one or more objects in the scene, each key frame comprising a plurality of map points associated with the one or more objects. The system comprises a computing device that a) receives a first one of the plurality of scans from the sensor; b) determines two-dimensional (2D) feature points of the one or more objects using the color and depth frame of the received scan; c) retrieves a key frame from the database; d) matches one or more of the 2D feature points with one or more of the map points in the key frame; e) generates a current pose of the one or more objects in the color and depth frame using the matched 2D feature points; f) inserts the color and depth frame into the database as a new key frame, including the matched 2D feature points as map points for the new key frame; and g) repeats steps a)-f) on each of the remaining scans, using the inserted new key frame for matching in step d), where the computing device tracks the pose of the one or more objects in the scene across the plurality of scans.

The invention, in another aspect, features a computerized method of tracking a pose of one or more objects represented in a scene. A sensor a) captures a plurality of scans of one or more objects in a scene, each scan comprising a color and depth frame. A computing device b) receives a first one of the plurality of scans from the sensor. The computing device c) determines two-dimensional (2D) feature points of the one or more objects using the color and depth frame of the received scan. The computing device d) retrieves a key frame from a database that stores one or more key frames of the one or more objects in the scene, each key frame comprising a plurality of map points associated with the one or more objects. The computing device e) matches one or more of the 2D feature points with one or more of the map points in the key frame. The computing device f) generates a current pose of the one or more objects in the color and depth frame using the matched 2D feature points. The computing device g) inserts the color and depth frame into the database as a new key frame, including the matched 2D feature points as map points for the new key frame. The computing device h) repeats steps b)-g) on each of the remaining scans, using the inserted new key frame for matching in step e), where the server computing device tracks the pose of the one or more objects in the scene across the plurality of scans.

Any of the above aspects can include one or more of the following features. In some embodiments, the computing device generates a 3D model of the one or more objects in the scene using the tracked pose information. In some embodiments, the step of inserting the color and depth frame into the database as a new key frame comprises converting the color and depth frame into a new key frame and converting the 2D feature points of the color and depth frame into map points of the new key frame; fusing one or more map points of the new key frame that have valid depth information with similar map points of one or more neighbor key frames; estimating a 3D position of one or more map points of the new key frame that do not have valid depth information; refining the pose of the new key frame and the one or more neighbor key frames fused with the new key frame; and storing the new key frame and associated map points into the database.

In some embodiments, converting the color and depth frame into a new key frame and converting the 2D feature points of the color and depth frame into map points of the new key frame comprises converting a 3D position of the one or more map points of the new key frame from a local coordinate system to a global coordinate system using the pose of the new key frame. In some embodiments, the computing device correlates the new key frame with the one or more neighbor key frames based upon a number of map points shared between the new key frame and the one or more neighbor key frames. In some embodiments, the step of fusing one or more map points of the new key frame that have valid depth information with similar map points of one or more neighbor key frames comprises: projecting each map point from the one or more neighbor key frames to the new key frame; identifying a map point with similar 2D features that is closest to a position of the projected map point; and fusing the projected map point from the one or more neighbor key frames to the identified map point in the new key frame.

In some embodiments, the step of estimating a 3D position of one or more map points of the new key frame that do not have valid depth information comprises: matching a map point of the new key frame that do not have valid depth information with a map point in each of two neighbor key frames; and determining a 3D position of the map point of the new key frame using linear triangulation with the 3D position of the map points in the two neighbor key frames. In some embodiments, the step of refining the pose of the new key frame and the one or more neighbor key frames fused with the new key frame is performed using local bundle adjustment. In some embodiments, the computing device deletes redundant key frames and associated map points from the database.

In some embodiments, the computing device determines a similarity between the new key frame and one or more key frames stored in the database, estimates a 3D rigid transformation between the new key frame and the one or more key frames stored in the database, selects a key frame from the one or more key frames stored in the database based upon the 3D rigid transformation, and merges the new key frame with the selected key frame to minimize drifting error. In some embodiments, the step of determining a similarity between the new key frame and one or more key frames stored in the database comprises determining a number of matched features between the new key frame and one or more key frames stored in the database. In some embodiments, the step of estimating a 3D rigid transformation between the new key frame and the one or more key frames stored in the database comprises: selecting one or more pairs of matching features between the new key frame and the one or more key frames stored in the database; determining a rotation and translation of each of the one or more pairs; and selecting a pair of the one or more pairs with a maximum inlier ratio using the rotation and translation. In some embodiments, the step of merging the new key frame with the selected key frame to minimize drifting error comprises: merging one or more feature points in the new key frame with one or more feature points in the selected key frame; and connecting the new key frame to the selected key frame using the merged feature points.

Other aspects and advantages of the invention will become apparent from the following detailed description, taken in conjunction with the accompanying drawings, illustrating the principles of the invention by way of example only.

### BRIEF DESCRIPTION OF THE DRAWINGS

FIG. 1 are exemplary symmetrical objects that can be scanned by the system.

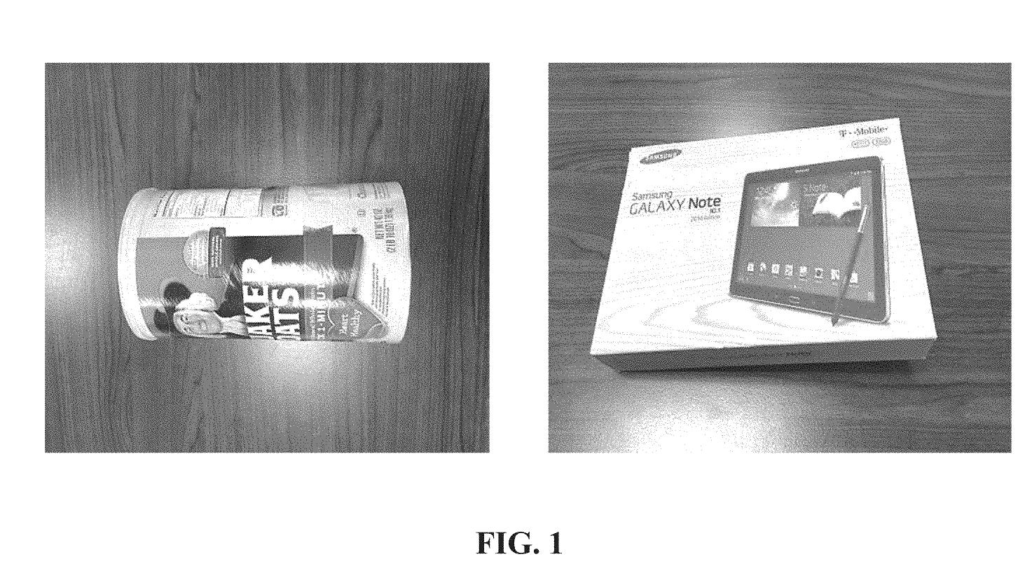

FIG. 2 is a block diagram of a system for tracking the pose of objects in a scene and generating a three-dimensional (3D) model of the objects.

FIG. 3 is a flow diagram of a method for determining sensor pose and key frame insertion.

FIG. 4A depicts 2D feature points detected from the color frame.

FIG. 4B depicts corresponding 2D features detected from the depth frame.

FIG. 5 depicts the matching of 2D feature points to map points.

FIG. 6 is an example sparse map showing 3D to 3D distance minimization.

FIG. 7 is an example sparse map showing 3D to 2D re-projection error minimization.

FIG. 8A depicts a sensor frame on the left and a key frame on the right, with a low number of matched pairs of points between the two frames, before insertion of a new key frame.

FIG. 8B depicts a sensor frame on the left and a key frame on the right, with a high number of matched pairs of points between the two frames, after insertion of a new key frame.

FIG. 9 is a flow diagram of a method for updating the mapping database with a new key frame.

FIG. 10A depicts the connectivity between two key frames before fusing similar map points.

FIG. 10B depicts the connectivity between two key frames after fusing similar map points.

FIG. 11A depicts map points that have valid depth information.

FIG. 11B depicts the matching of feature points without valid depth information between two key frames using 3D position estimation.

FIG. 11C depicts map points that have both valid and invalid depth information as a result of 3D position estimation.

FIG. 12A is a scene.

FIG. 12B depicts the scene as map points in a key frame.

FIG. 13A depicts a series of map points where redundant map points have not been deleted.

FIG. 13B depicts the series of map points after redundant map points have been deleted.

FIG. 14 is a flow diagram of a method for closing the loop for key frames in the mapping database.

FIG. 15 depicts a latest inserted key frame on the left and a key frame from the mapping database on the right that have been matched.

FIG. 16A depicts the initial position of the latest inserted key frame and the initial position of the matched key frame from the mapping database in the global coordinate system.

FIG. 16B depicts the positions of the latest inserted key frame and the matched key frame after 3D rigid transformation occurs.

FIG. 17A depicts key frames without loop closure.

FIG. 17B depicts key frames after loop closure is completed.

### DETAILED DESCRIPTION

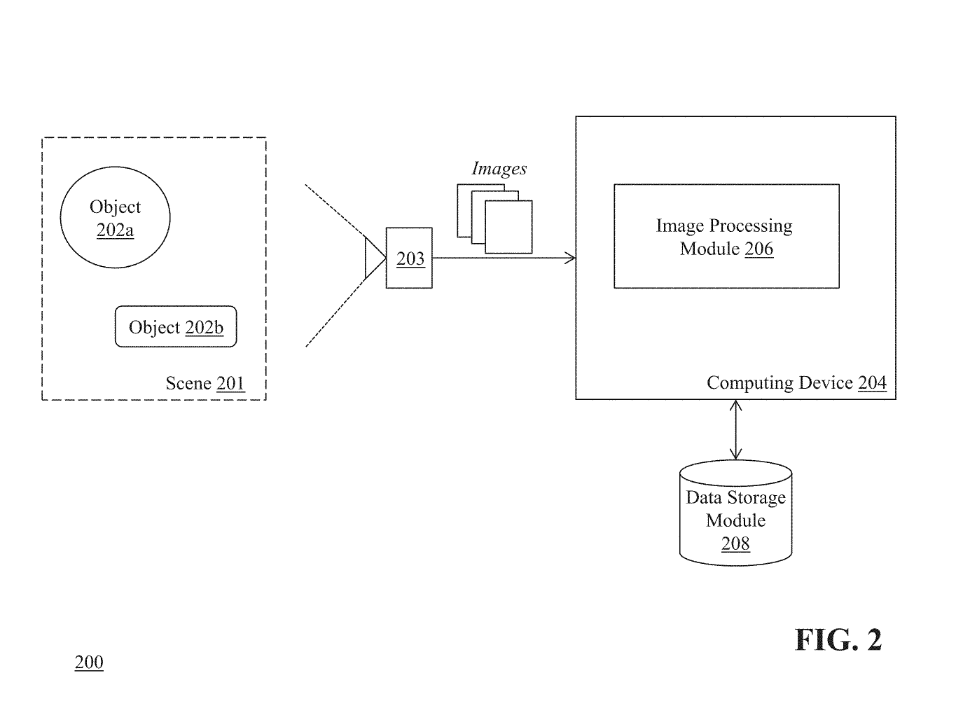

FIG. 2 is a block diagram of a system 200 for tracking the pose of objects represented in a scene, and generating a three-dimensional (3D) model of the objects represented in the scene, including executing the sparse SLAM and dense SLAM techniques described herein. The systems and methods described in this application can utilize the object recognition and modeling techniques as described in U.S. patent application Ser. No. 14/324,891, titled “Real-Time 3D Computer Vision Processing Engine for Object Recognition, Reconstruction, and Analysis,” and as described in U.S. patent application Ser. No. 14/849,172, titled “Real-Time Dynamic Three-Dimensional Adaptive Object Recognition and Model Reconstruction,” both of which are incorporated herein by reference. Such methods and systems are available by implementing the Starry Night plug-in for the Unity 3D development platform, available from VanGogh Imaging, Inc. of McLean, Va.

The system 200 includes a sensor 203 coupled to a computing device 204. The computing device 204 includes an image processing module 206. In some embodiments, the computing device can also be coupled to a data storage module 208, e.g., used for storing certain 3D models, color images, and other data as described herein.

The sensor 203 is positioned to capture images (e.g., color images) of a scene 201 which includes one or more physical objects (e.g., objects 202a-202b). Exemplary sensors that can be used in the system 200 include, but are not limited to, 3D scanners, digital cameras, and other types of devices that are capable of capturing depth information of the pixels along with the images of a real-world object and/or scene to collect data on its position, location, and appearance. In some embodiments, the sensor 203 is embedded into the computing device 204, such as a camera in a smartphone, for example.

The computing device 204 receives images (also called scans) of the scene 201 from the sensor 203 and processes the images to generate 3D models of objects (e.g., objects 202a-202b) represented in the scene 201. The computing device 204 can take on many forms, including both mobile and non-mobile forms. Exemplary computing devices include, but are not limited to, a laptop computer, a desktop computer, a tablet computer, a smart phone, augmented reality (AR)/virtual reality (VR) devices (e.g., glasses, headset apparatuses, and so forth), an internet appliance, or the like. It should be appreciated that other computing devices (e.g., an embedded system) can be used without departing from the scope of the invention. The mobile computing device 202 includes network-interface components to connect to a communications network. In some embodiments, the network-interface components include components to connect to a wireless network, such as a Wi-Fi or cellular network, in order to access a wider network, such as the Internet.

The computing device 204 includes an image processing module 206 configured to receive images captured by the sensor 203 and analyze the images in a variety of ways, including detecting the position and location of objects represented in the images and generating 3D models of objects in the images.

The image processing module 206 is a hardware and/or software module that resides on the computing device 204 to perform functions associated with analyzing images capture by the scanner, including the generation of 3D models based upon objects in the images. In some embodiments, the functionality of the image processing module 106 is distributed among a plurality of computing devices. In some embodiments, the image processing module 206 operates in conjunction with other modules that are either also located on the computing device 204 or on other computing devices coupled to the computing device 204. An exemplary image processing module is the Starry Night plug-in for the Unity 3D engine or other similar libraries, available from VanGogh Imaging, Inc. of McLean, Va. It should be appreciated that any number of computing devices, arranged in a variety of architectures, resources, and configurations (e.g., cluster computing, virtual computing, cloud computing) can be used without departing from the scope of the invention.

The data storage module 208 (e.g., a database) is coupled to the computing device 204, and operates to store data used by the image processing module 206 during its image analysis functions. The data storage module 208 can be integrated with the server computing device 204 or be located on a separate computing device.

As described herein, the sparse SLAM technique comprises three processing modules that are executed by the image processing module 206:

1) Tracking—the tracking module comprises matching of the input from the sensor (i.e., color and depth frames) to the key frames and map points contained in the mapping database to get the sensor pose in real time. The key frames are a subset of the overall input sensor frames that are transformed to a global coordinate system. The map points are two-dimensional (2D) feature points, also containing three-dimensional (3D) information, in the key frames.

2) Mapping—the mapping module builds the mapping database which as described above includes the key frames and map points, based upon the input received from the sensor and the sensor pose as processed by the tracking module.

3) Loop Closing—the loop closing module corrects drifting errors contained in the data of the mapping database that is accumulated during tracking of the object.

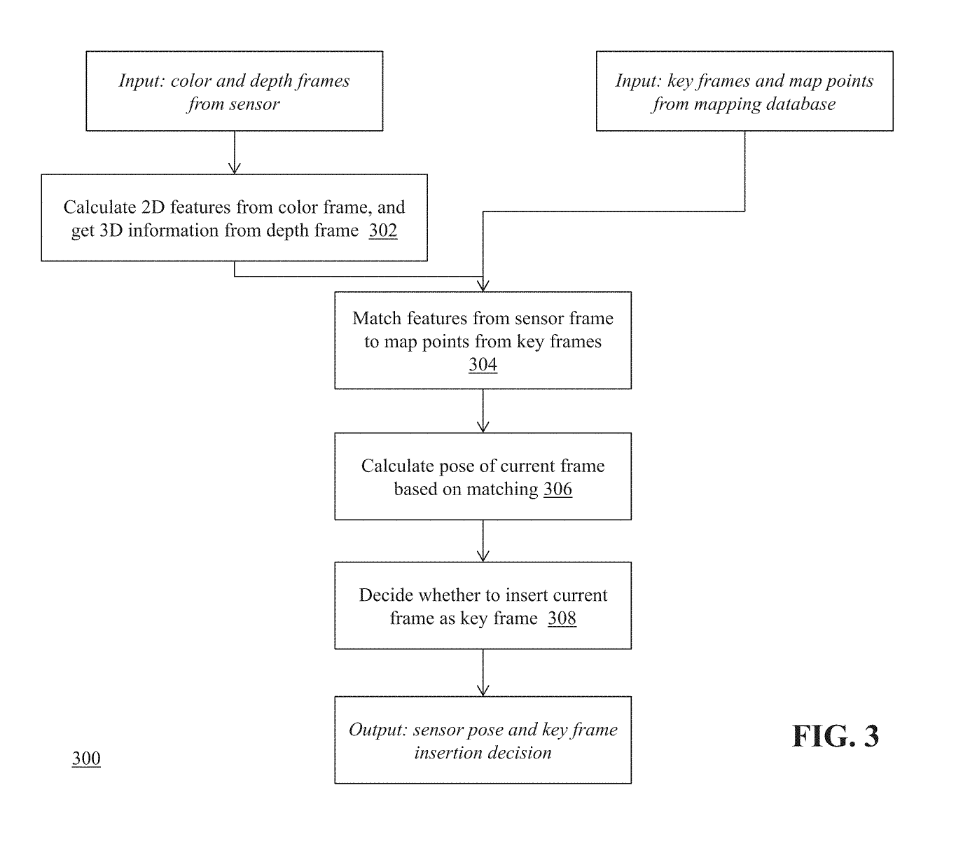

FIG. 3 is a flow diagram of a method 300 for determining the sensor pose and key frame insertion (e.g., the tracking module processing), using the system 200 of FIG. 2. The image processing module 206 receives color and depth frames as input from the sensor 203. The module 206 calculates (302) 2D features of the object (e.g., 202a) from the color frame and gets 3D information of the object 202a from the depth frame. For example, the image processing module 206 detects 2D color feature points from the color frame using, e.g., a FAST algorithm as described in E. Rosten et al., “Faster and better: a machine learning approach to corner detection,” IEEE Trans. Pattern Analysis and Machine Intelligence (2010) (which is incorporated herein by reference), a Harris Corner algorithm as described in C. Harris et al., “A combined corner and edge detector,” Plessey Research Roke Manor (1988) (which is incorporated herein by reference), or other similar algorithms. Then the module 206 calculates the 2D features using, e.g., a SURF algorithm as described in H. Bay et al., “Speeded Up Robust Features (SURF),” Computer Vision and Image Understanding 110 (2008) 346-359 (which is incorporated herein by reference), an ORB algorithm as described in E. Rublee et al., “ORB: an efficient alternative to SIFT or SURF,” ICCV '11 Proceedings of the 2011 International Conference on Computer Vision, pp. 2564-2571 (2011) (which is incorporated herein by reference), a SIFT algorithm as described in D. G. Lowe, “Distinctive image features from scale-invariant keypoints,” International Journal of Computer Vision 60(2), 91-110 (2004) (which is incorporated herein by reference), or other similar algorithms. In one embodiment, FAST was used for feature detection and ORB was used for feature calculation.

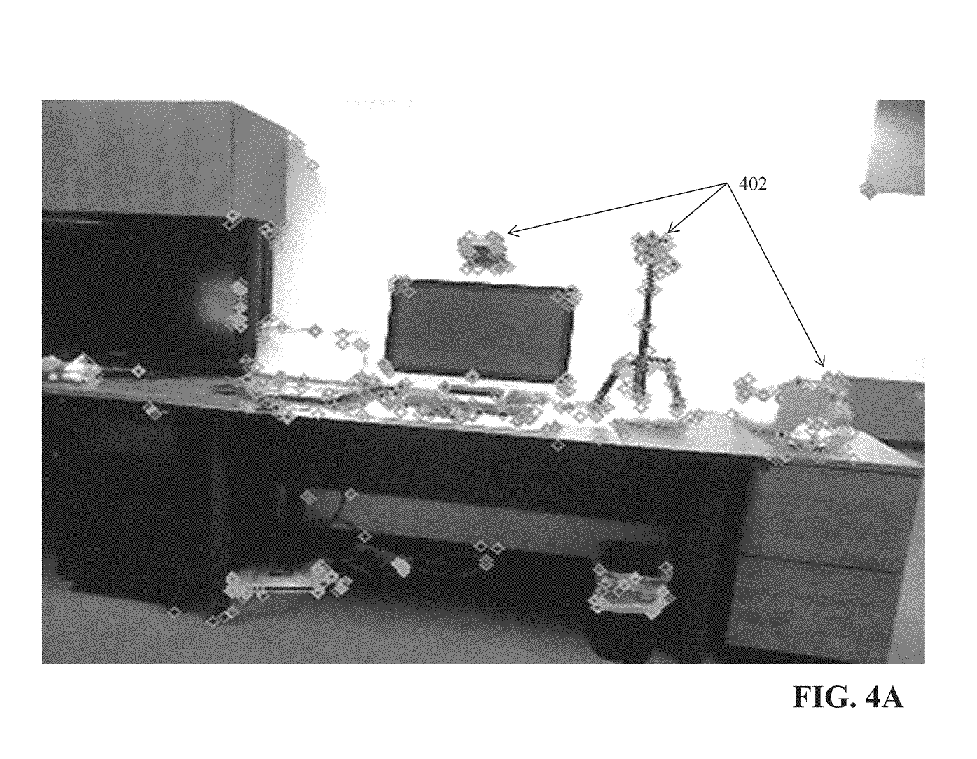

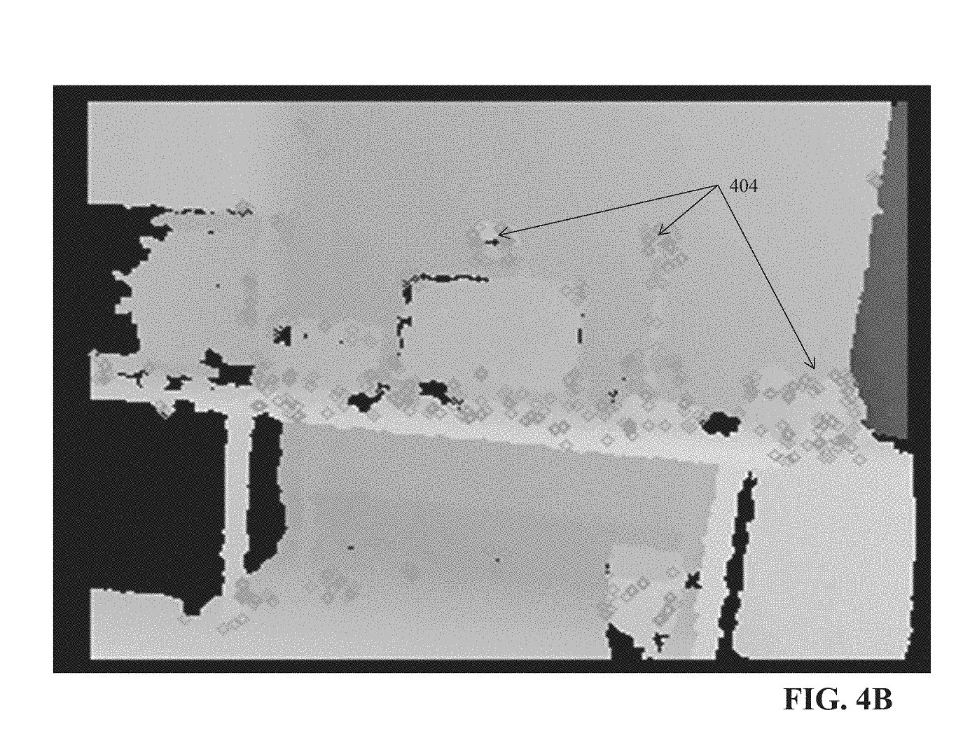

After the module 206 detects and calculates the 2D feature points, the module 206 gets viewing directions, or normal of the 2D feature points. If 2D feature points have corresponding valid depth values in depth frame, the module 206 also gets the 3D positions in the sensor coordinate system. FIG. 4A depicts the 2D feature points detected from the color frame by the image processing module 206, and FIG. 4B depicts the corresponding 2D features detected from the depth frame by the module 206. As shown in FIG. 4A, the scene contains several objects (e.g., a computer monitor, desk, cabinets, and so forth) and the 2D feature points (e.g., 402) are detected at various places in the scene. The same scene is shown in FIG. 4B, with 2D features (e.g., 404) detected from the depth frame.

Turning back to FIG. 3, the image processing module 206 then receives key frames and map points from mapping database 208 and matches (304) 2D features from the sensor frame to map points in the key frames. It should be appreciated that the module 206 uses the first frame captured by the sensor 203 as the first key frame, in order to provide mapping data for tracking because the mapping database 208 does not yet have any key frames. Subsequent key frame insertion decisions are made by the module 206, as described below.

The module 206 matches 2D features from the sensor frame to map points in certain key frames. The module 206 selects key frames from the mapping database using the following exemplary methods: 1) key frames that are around the sensor position in global coordinate systems; and 2) key frames in which there are the most number of matching pairs of map points in the key frame and 2D feature points in the previous sensor frame. It should be appreciated that other techniques to select key frames from the mapping database can be used.

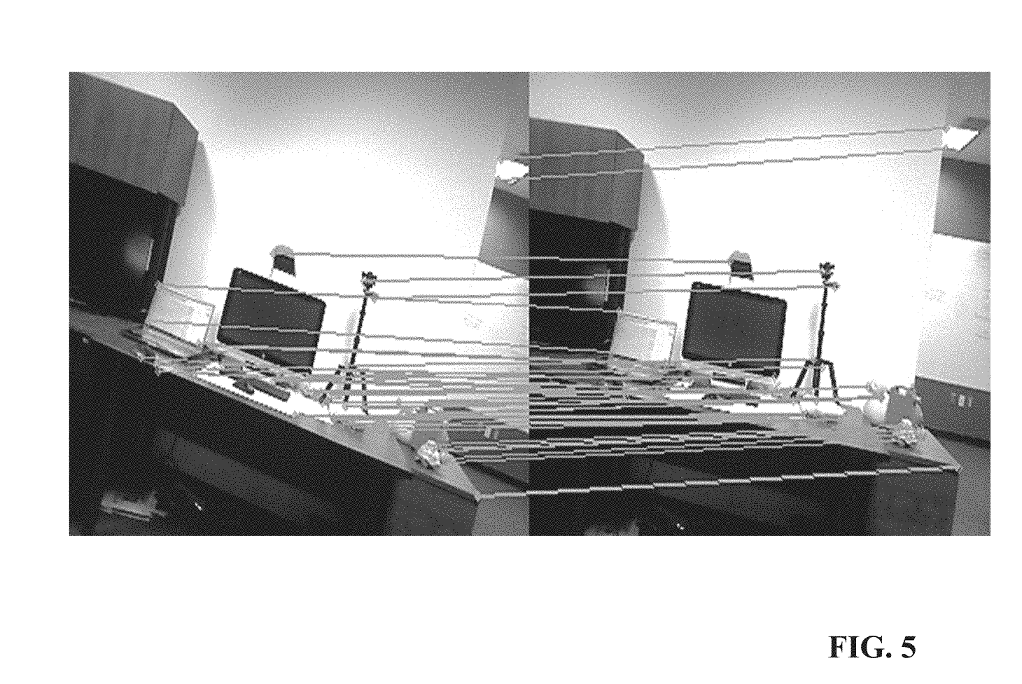

The module 206 matches map points to 2D feature points by, e.g., using 3D+2D searching. For example, the module 206 transforms color feature points in the current frame using the 3D pose of the prior sensor frame to estimate the global positions of the color feature points. Then, the module 206 searches for each map point in the 3D space surrounding the transformed color feature points, and looks for the most similar transformed feature point from the sensor frame. FIG. 5 depicts the matching of 2D feature points to map points. The left-hand image in FIG. 5 is the sensor frame containing the 2D feature points, and the right-hand image in FIG. 5 is the key frame (selected from the mapping database) which contains the map points. As shown in FIG. 5, each 2D feature point in the sensor frame is matched to the corresponding map point in the key frame (as shown by the lines connecting the pairs of points). An example of such feature matching is described in D. Nister et al., “Scalable recognition with a vocabulary tree,” CVPR '06 Proceedings of the 2006 IEEE Computer Society Conference on Computer Vision and Pattern Recognition—Vol. 2, pp. 2161-2168 (2006) (which is incorporated herein by reference). To increase the reliability, once 3D+2D searching fails, the module 206 can perform an alternative 2D+3D searching. The module 206 matches features of all key points from a loose frame to all map points in the key frame. Then, the matching pairs are further refined by RANSAC to maximize the number of inliers that meet a 3D distance and 2D re-projection error requirement.

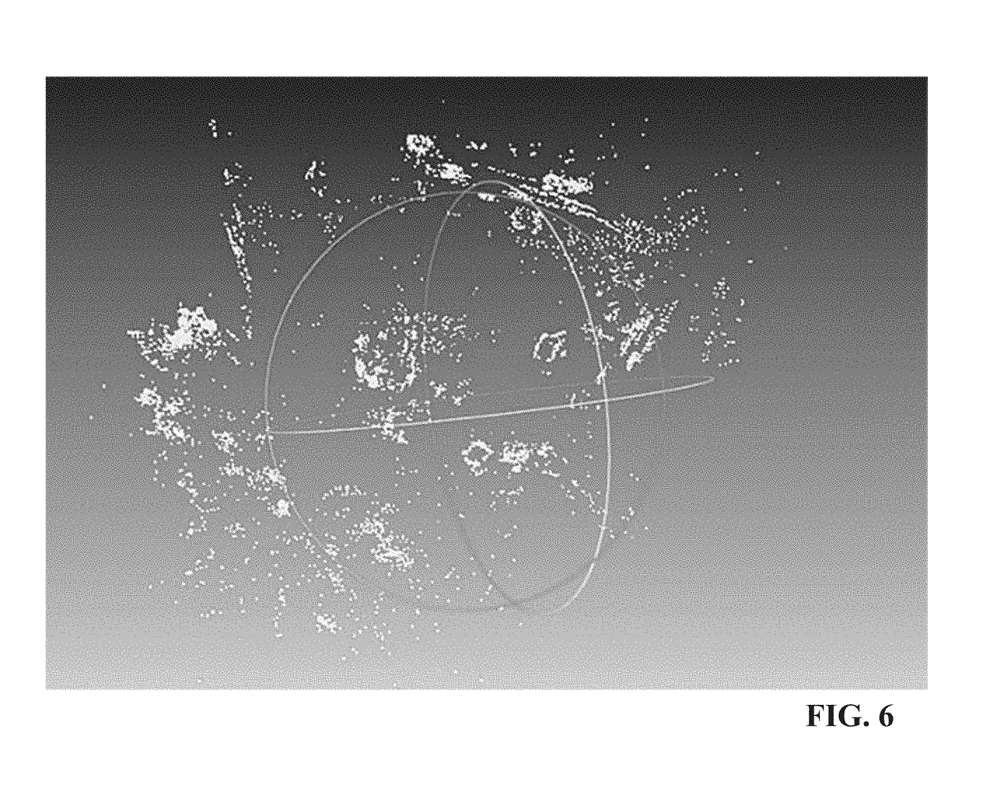

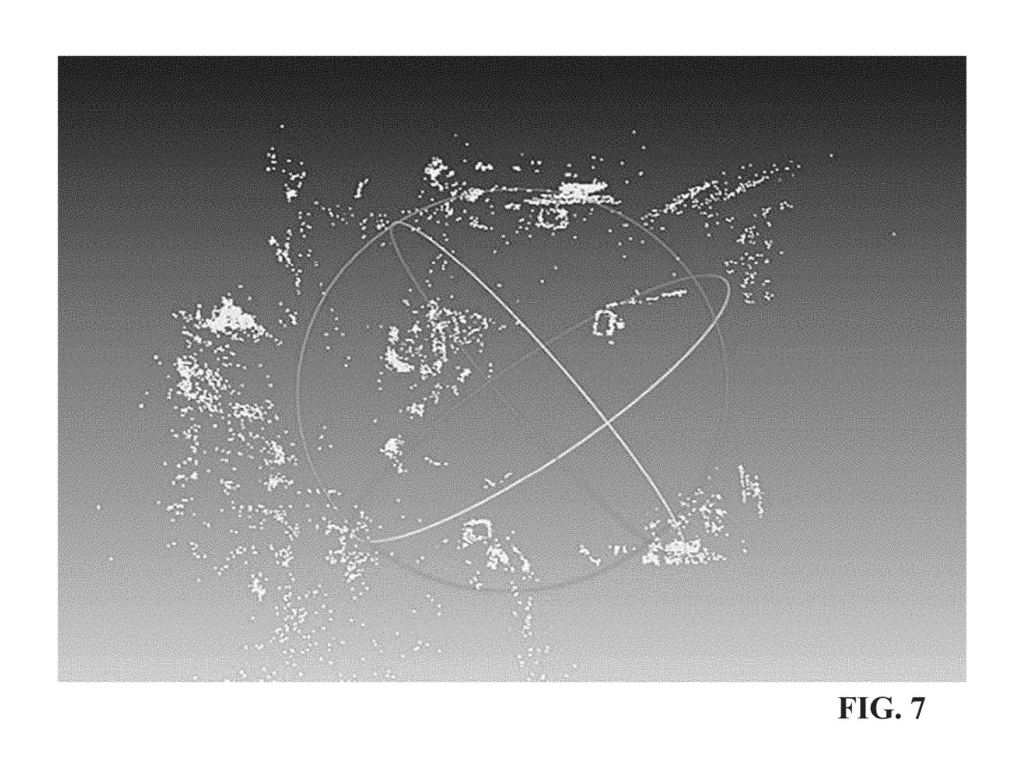

Turning back to FIG. 3, the image processing module 206 then calculates (306) the pose of the current frame based upon the matching step. For example, once the 2D feature points have been associated with map points in the global coordinate system, the module 206 solves the pose of the sensor frame by, e.g., minimizing 3D to 3D distance using a Singular Value Decomposition technique, if 2D feature points have valid 3D positions (FIG. 6 is an example sparse map showing such 3D to 3D distance minimization), or by minimizing 3D to 2D re-projection error using motion only Bundle Adjustment, if 2D feature points do not have valid 3D positions (FIG. 7 is an example sparse map showing such 3D to 2D re-projection error minimization). Bundle Adjustment is described in M. Kaess, “iSAM: Incremental Smoothing and Mapping,” IEEE Transactions on Robotics, Manuscript, Sep. 7, 2008 (which is incorporated herein by reference) and R. Kummerle et al., “g²o: A General Framework for Graph Optimization,” IEEE International Conference on Robotics and Automation, pp. 3607-3613 (2011) (which is incorporated herein by reference). It should be noted that compared to minimizing 3D to 3D distance, minimizing 3D to 2D re-projection error leads to less jitter and drifting but slower speed in tracking. Minimizing 3D to 3D distance is better suited for high frames-per-second (FPS) applications in small scenes, while minimizing 3D to 2D re-projection error works better in large scenes.

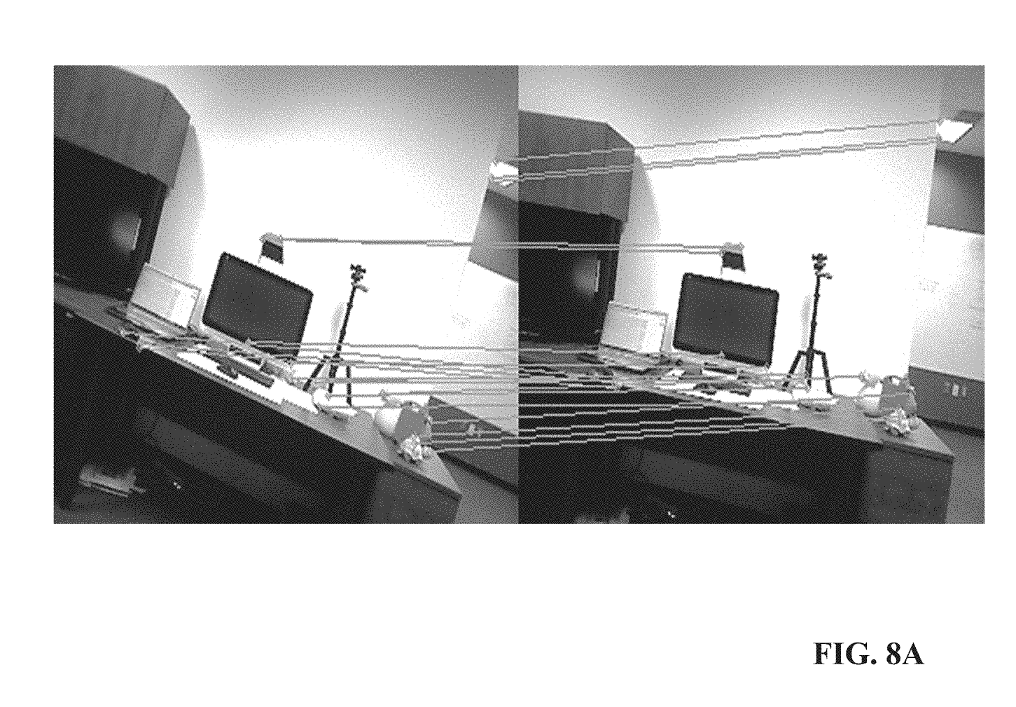

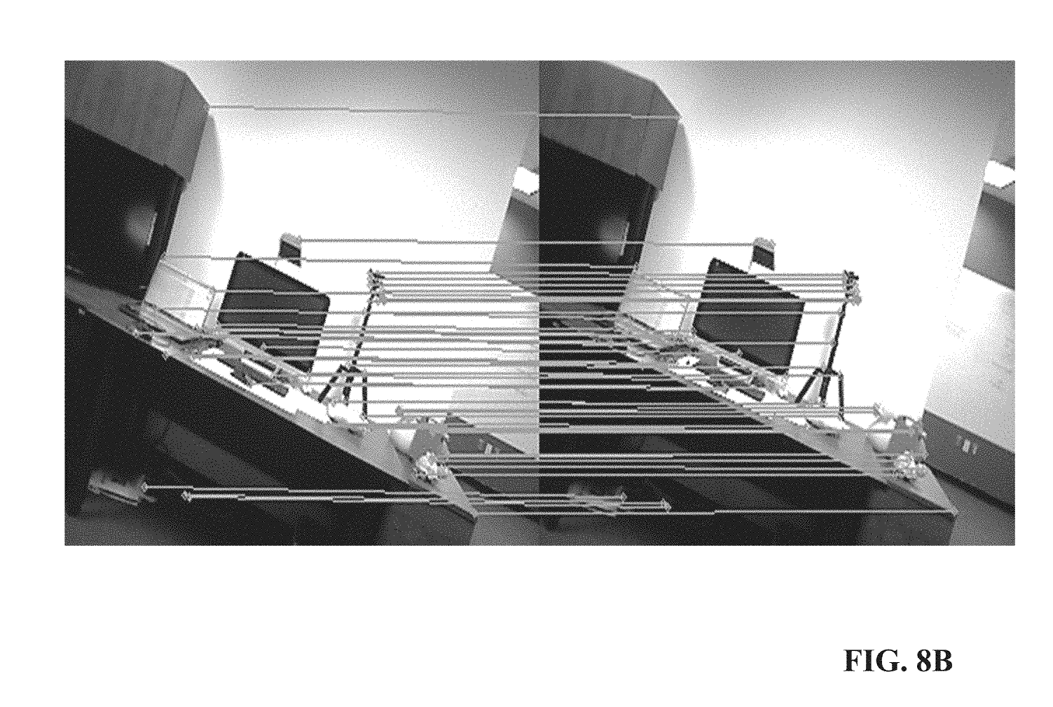

Next, the image processing module 206 decides (308) whether to insert the current sensor frame as a new key frame in the mapping database 208. For example, once the current sensor frame does not have enough feature points that match with the map points in the key frames, the module 206 inserts the current sensor frame in the mapping database 208 as a new key frame in order to guarantee tracking reliability of subsequent sensor frames. FIG. 8A depicts a sensor frame on the left and a key frame on the right, with a low number of matched pairs of points between the two frames, before insertion of a new key frame. The matched pairs of points are denoted in FIG. 8A by a line connecting each point in a pair of matched points. In contrast, FIG. 8B depicts a sensor frame on the left and a key frame on the right, with a high number of matched pairs of points between the two frames, after insertion of a new key frame. The matched pairs of points are denoted in FIG. 8B by a line connecting each point in a pair of matched points.

Once the key frame insertion decision has been made, the image processing module 206 generates the pose of the sensor 203 and the key frame insertion decision as output. The module 206 then updates the mapping database with the new key frame and corresponding map points in the frame—if the decision was made to insert the current sensor frame as a new key frame. Otherwise, the module 206 skips the mapping database update and executes the tracking module processing of FIG. 3 on the next incoming sensor frame.

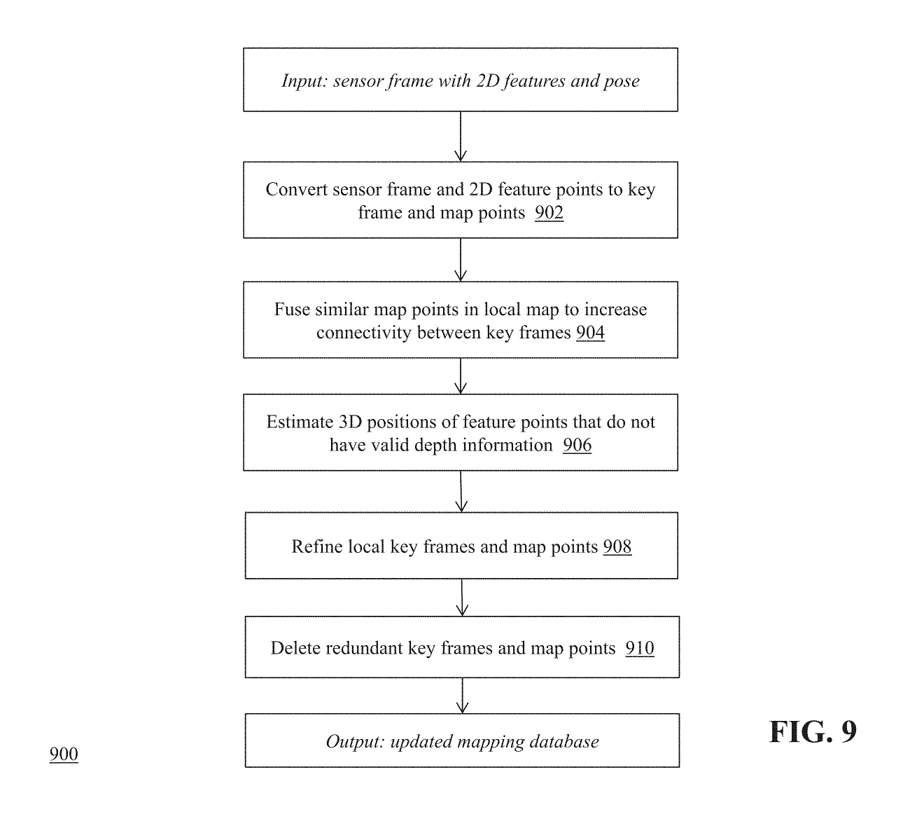

FIG. 9 is a flow diagram of a method 900 for updating the mapping database 208 with a new key frame (e.g., the mapping module processing), using the system 200 of FIG. 2. The image processing module 206 receives the selected sensor frame and corresponding 2D feature points and pose data. The module 206 converts (902) the selected sensor frame and 2D feature points into a key frame and corresponding map points. For example, the module 206 saves the color and depth frame as a key frame in the mapping database 208 and the 2D feature points are saved in the mapping database 208 as map points. The module 206 converts the 3D information, such as the point map generated from the depth map and the 3D positions of the feature points, if the feature points have valid depth values, from the local sensor coordinate system to the global coordinate system using the pose of the sensor frame. The selected sensor frame that is being inserted as a new key frame is correlated to other key frames based upon, e.g., the number of map points shared with other key frames. It should be appreciated that the continual insertion of new key frames and map points is important to maintain reliable tracking for sparse SLAM.

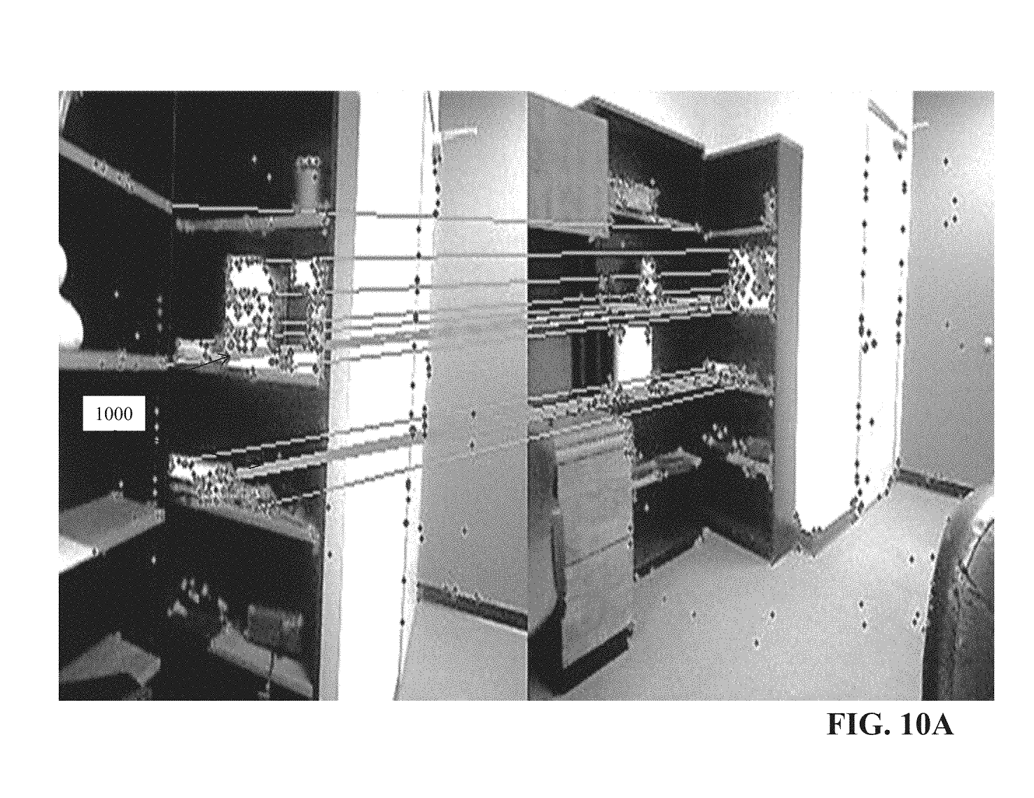

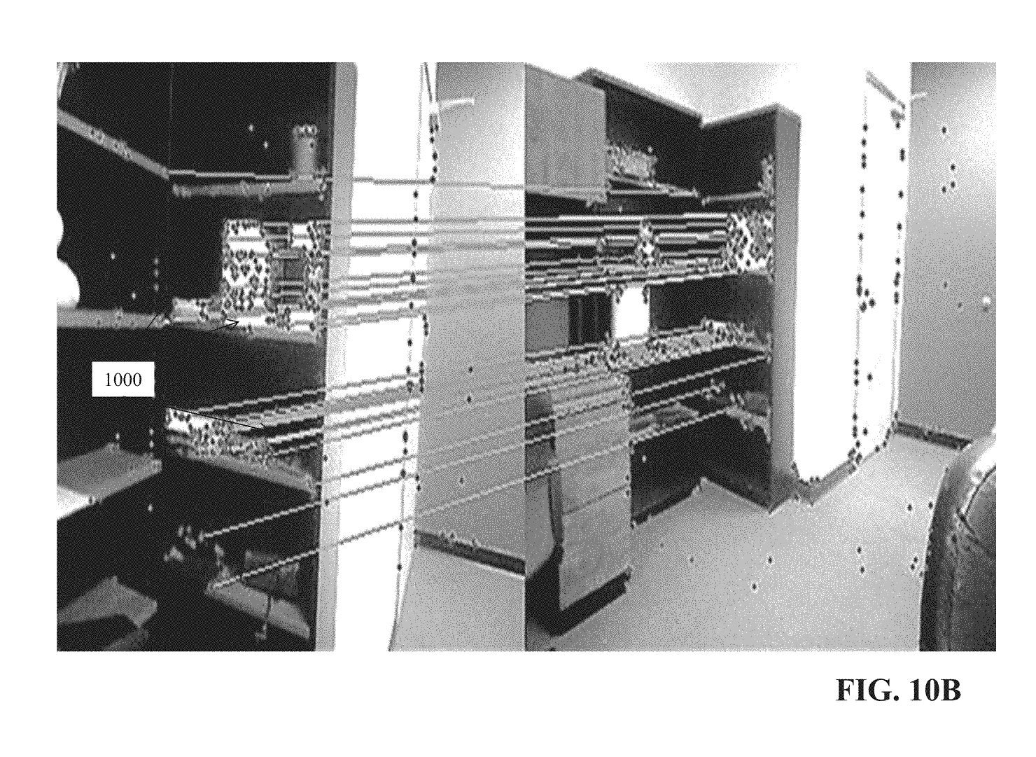

The image processing module 206 then fuses (904) similar map points between the newly-inserted key frame and its neighbor key frames. The fusion is achieved by similar 3D+2D searching with tighter thresholds, such as searching window size and feature matching threshold. The module 206 projects every map point in neighboring key frames from the global coordinate system to the newly-inserted key frame and vice versa. Then, the projected map point searches for the map point with similar 2D features that is closest to its projected position in the newly-inserted key frame. Fusing similar map points naturally increases the connectivity between the newly-inserted key frame and its neighbor key frames. It benefits both tracking reliability and mapping, because more map points and key frames are involved in tracking and local bundle adjustment in mapping. FIG. 10A depicts the connectivity between two key frames (i.e., each line 1000 indicates a connection between similar map points in each frame) before the module 206 has fused similar map points, while FIG. 10B depicts the connectivity between the two key frames after the module 206 has fused similar map points. As shown, there is an increase in the connectivity between similar map points after the module 206 has fused similar map points.

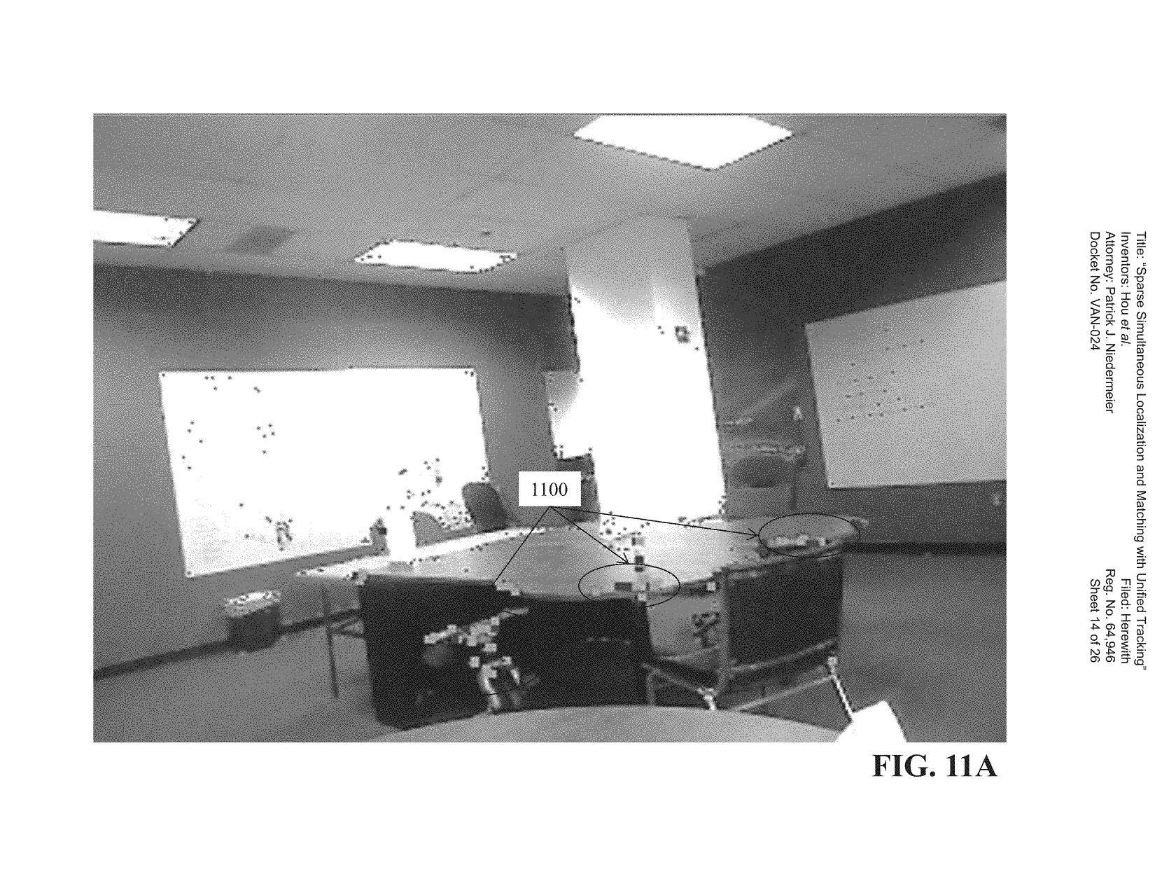

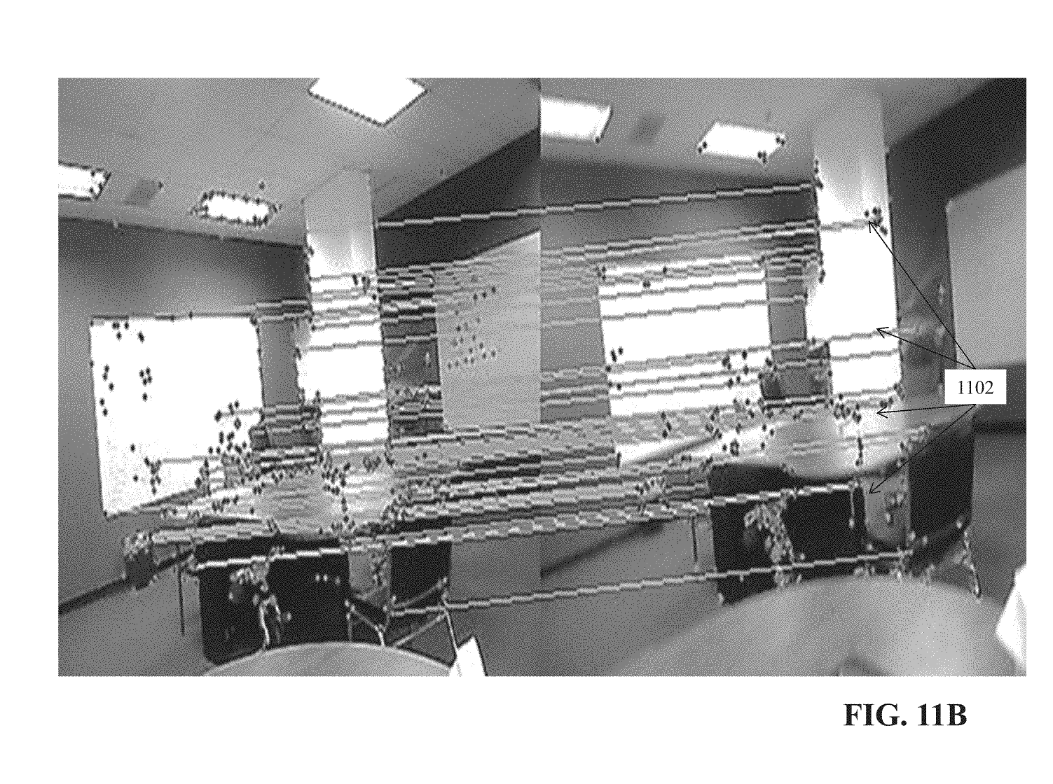

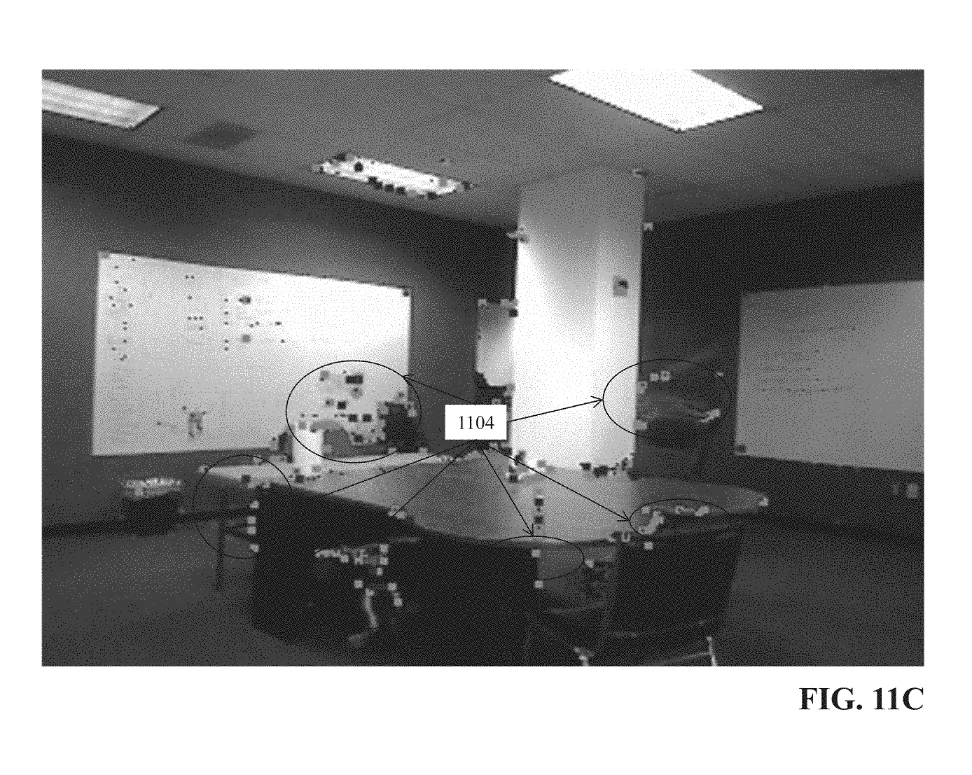

In order to handle scenes without enough depth information, the image processing module 206 also estimates (906) 3D positions for feature points that do not have valid depth information. Estimation is achieved by matching feature points without valid depth values across two key frames subject to an epipolar constraint and feature distance constraints. The module 206 can then calculate the 3D position by linear triangulation to minimize the 2D re-projection error, described by Richard Hartley and Andrew Zisserman, “Multiple View Geometry in Computer Vision”, Cambridge University Press, 2003 (which is incorporated herein by reference). To achieve a good accuracy level, 3D positions are estimated only for two features points with enough parallax. The estimated 3D position accuracy of each map point is improved as more key frames are matched to the map point and more key frames are involved in the next step—local key frame and map point refinement. FIG. 11A depicts only those map points (examples shown in circled areas 1100) that have valid depth information, FIG. 11B depicts the matching of feature points (i.e., each line 1102 indicates a connection between feature points) without valid depth information between two key frames using the 3D position estimation process, and FIG. 11C depicts the map points that have both valid and invalid depth information as a result of the 3D position estimation process. As shown, the number of map points has increased from FIG. 11A to 11C using the 3D position estimation process.

The image processing module 206 then refines (908) the poses of the newly-inserted key frame and correlated key frames, and 3D positions of the related map points. The refinement is achieved by local bundle adjustment, which optimizes the poses of the key frames and 3D position of the map points by, e.g., minimizing the re-projection error of map points relative to key frames.

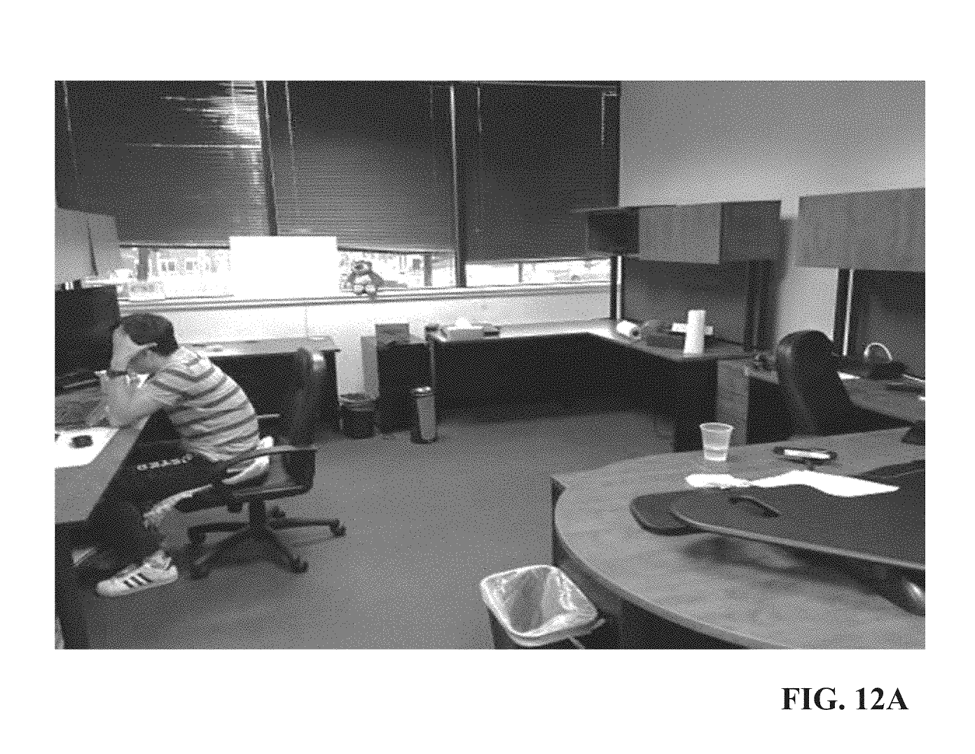

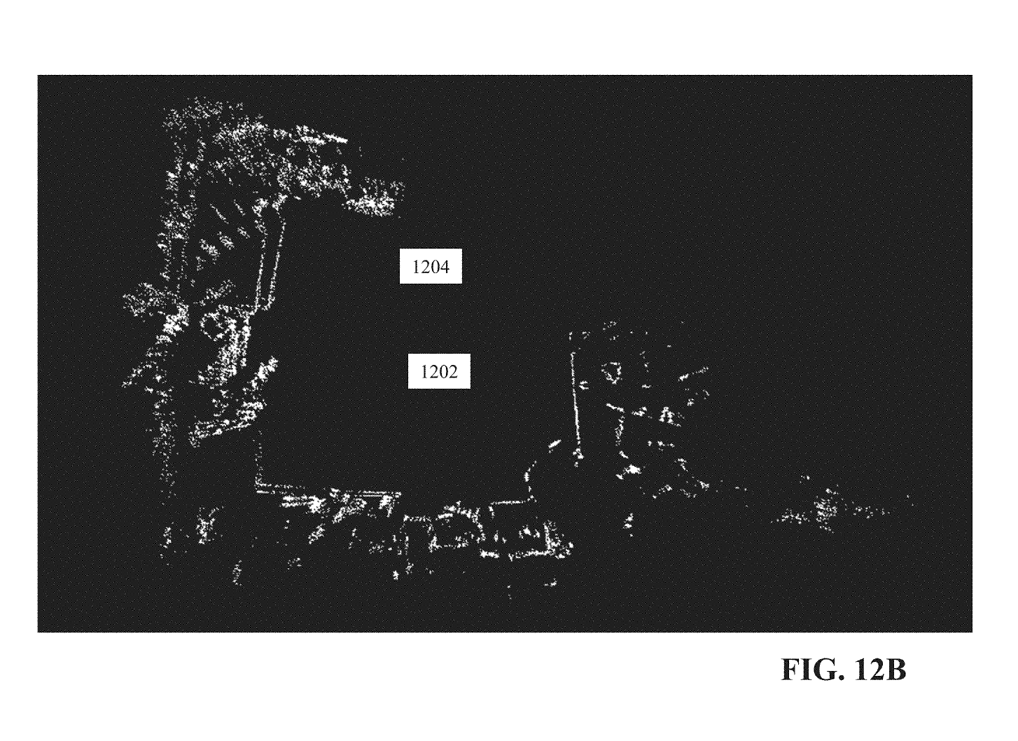

FIG. 12A is a scene (e.g., an office room) and FIG. 12B depicts the same scene as map points in a key frame. As shown in FIG. 12B, certain map points 1204 that have been refined accumulate less bending error than map points 1202 that have not been refined.

Turning back to FIG. 9, to keep the mapping database 208 concise and accelerate performance of the sparse SLAM technique, the module 206 deletes (910) redundant key frames and map points from the database 208. For example, a redundant key frame can be defined as a key frame in which most of the map points are shared with other key frames, and can be observed in closer distance and finer scale in those other key frames. A redundant map point, for example, can be defined as a map point that is not shared by enough key frames. It should be appreciated that there may be other ways to define redundant key frames and map points for deletion.

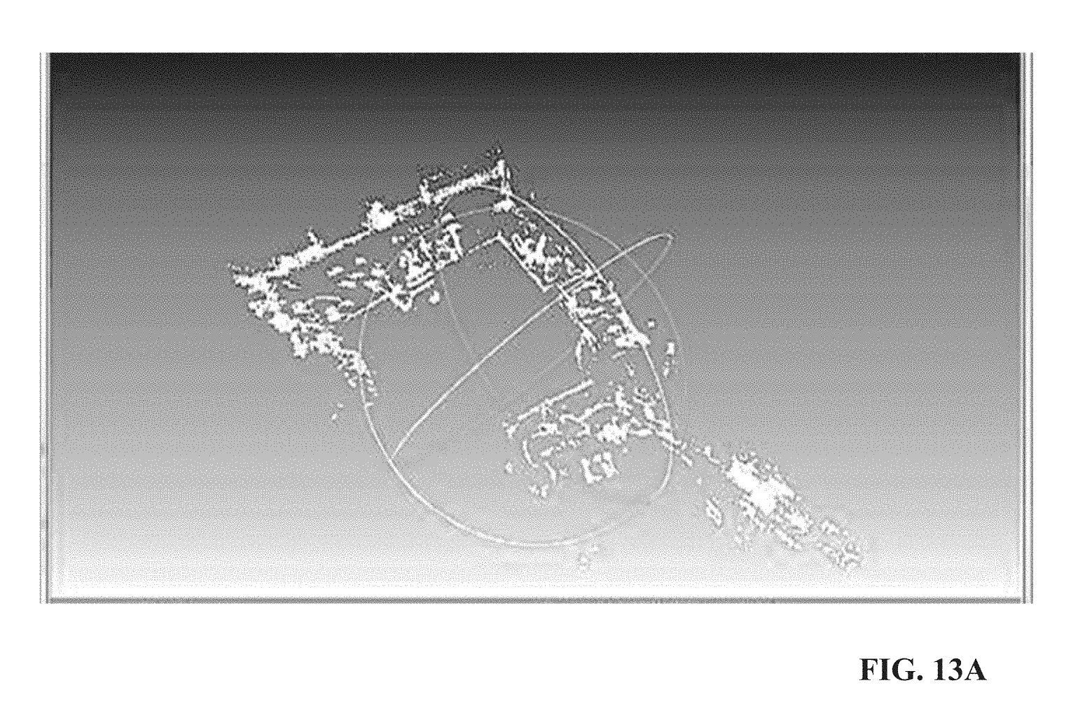

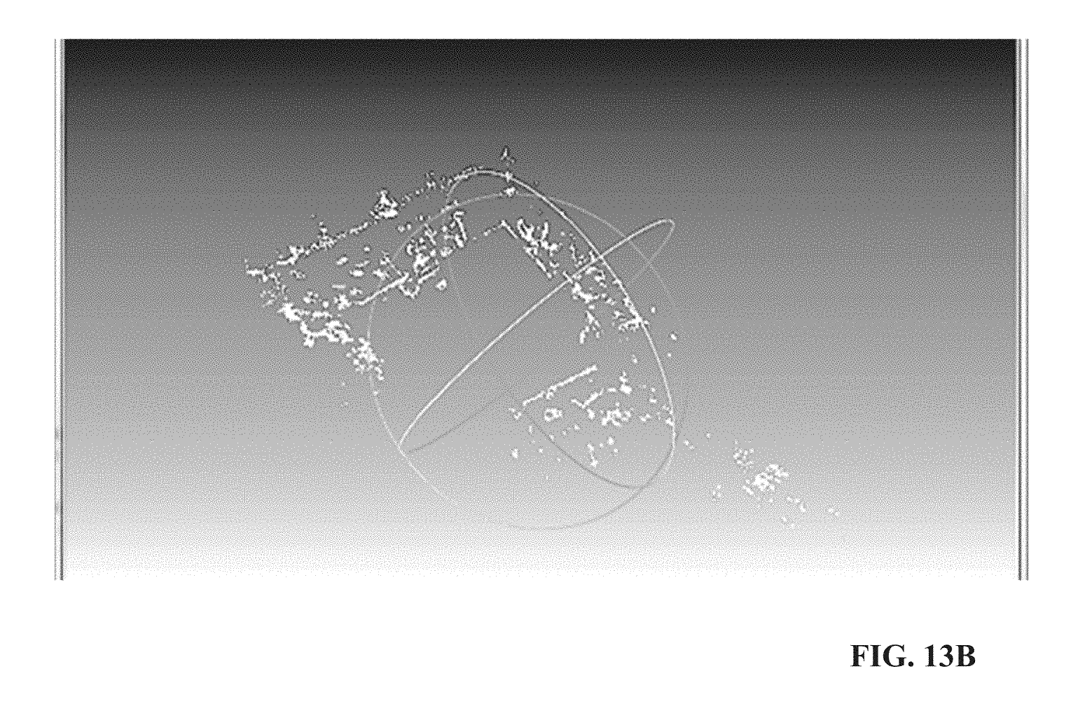

FIG. 13A depicts a series of map points where redundant map points have not been deleted, while FIG. 13B depicts the series of map points after redundant map points have been deleted. After the new key frame is inserted, the result is an updated mapping database 208 that the module 206 uses for subsequent tracking processes.

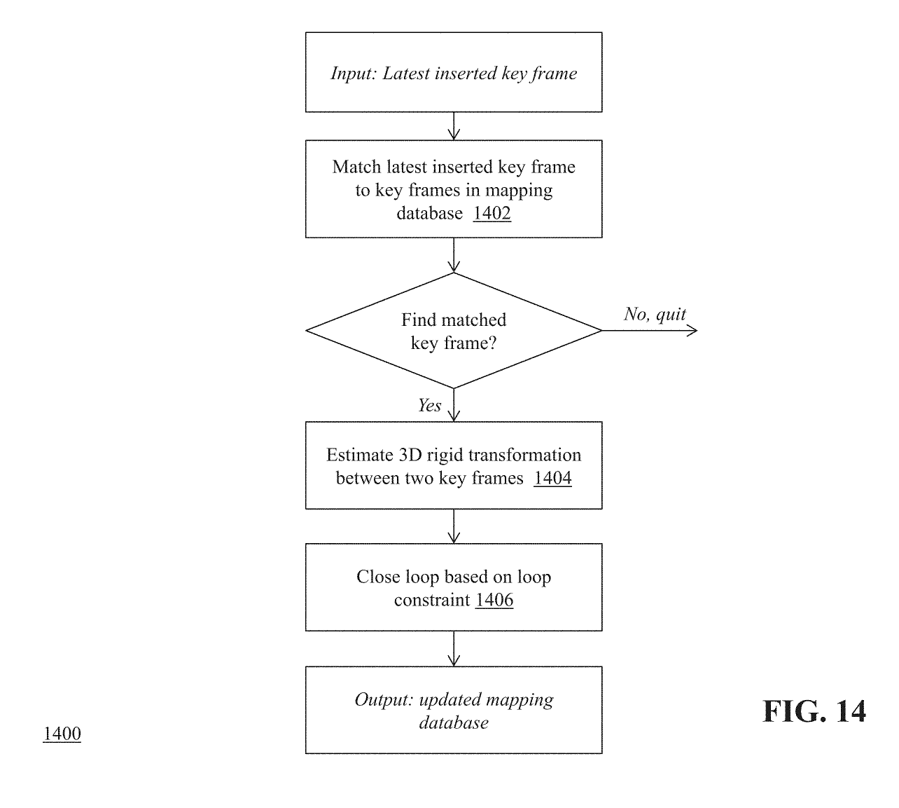

In conjunction with the mapping module processing for inserting a new key frame into the mapping database 208, the image processing module 206 also performs loop closing processing to minimize drifting error in the key frames. FIG. 14 is a flow diagram of a method 1000 for closing the loop for key frames in the mapping database 208 (e.g., the loop closing module processing), using the system 200 of FIG. 2. The image processing module 206 receives the latest inserted key frame as input, and matches (1402) the latest inserted key frame to the key frames in the mapping database 208 to detect a loop and if any key frame in the mapping database 208 matches with the latest inserted key frame, the frames are processed to close the loop. For example, the module 206 calculates a similarity between the latest inserted key frame and key frames from the database based upon any of a number of different techniques, including bag-of-words, or even by directly matching the features between the two key frames. Any key frame(s) in the mapping database 208 that have a high similarity (e.g., large number of matched features) are deemed to be matched key frames relative to the latest inserted key frame and the module 206 detects a loop between the frames.

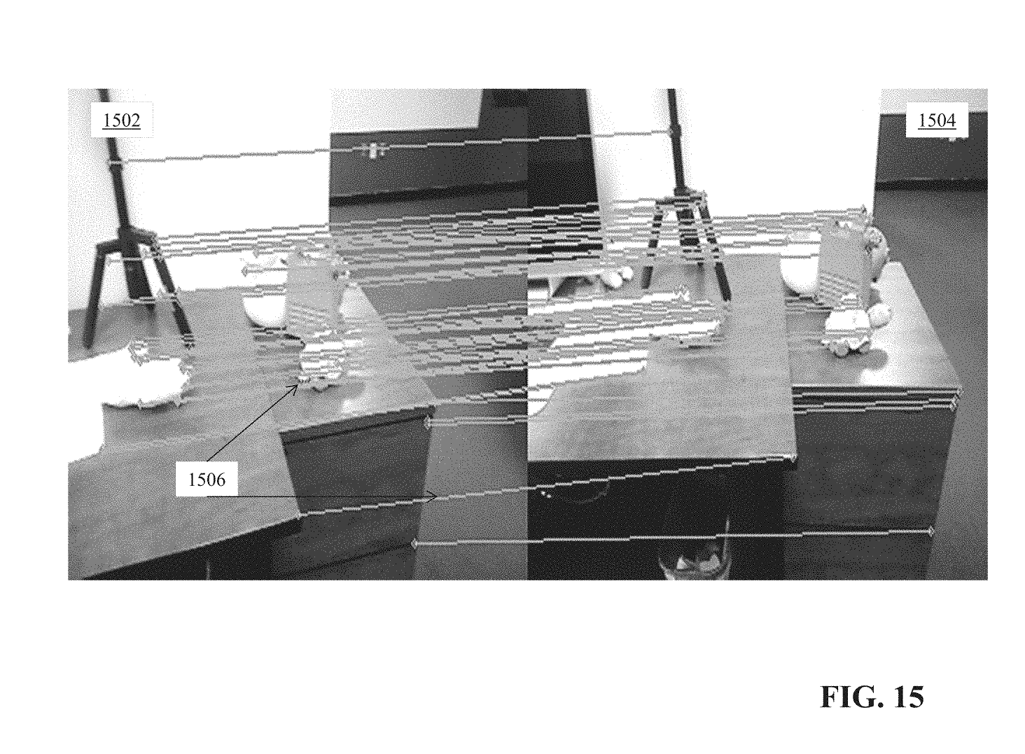

FIG. 15 depicts a latest inserted key frame 1502 on the left and a key frame 1504 from the mapping database 208 on the right that have been matched. The matched pairs of feature points between the two key frames are shown as connected by lines 1506.

Turning back to FIG. 14, after the image processing module 206 detects matching key frames in the mapping database 208, the module 206 estimates (1404) the 3D rigid transformation between the latest inserted key frame and each matched key frame using, e.g., a RANSAC algorithm—which estimates rotation and translation by randomly choosing the feature matching pairs between two key frames, calculating rotation and translation based on the matching pairs and choosing the best rotation and translation with the maximum inlier ratio. Among all matched key frames, only the key frame with the highest inlier ratio is selected for the next step.

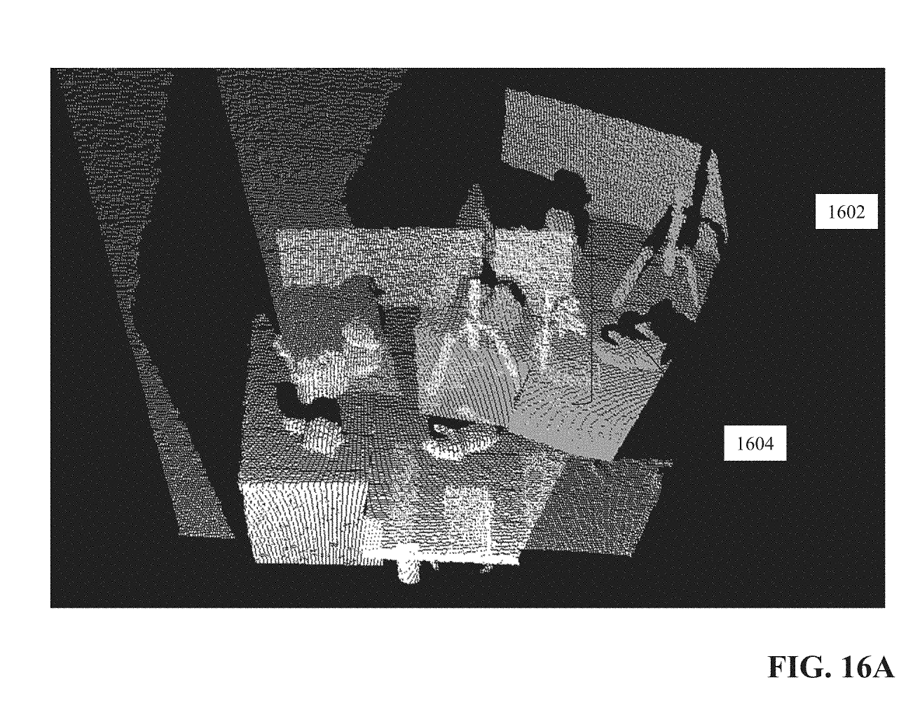

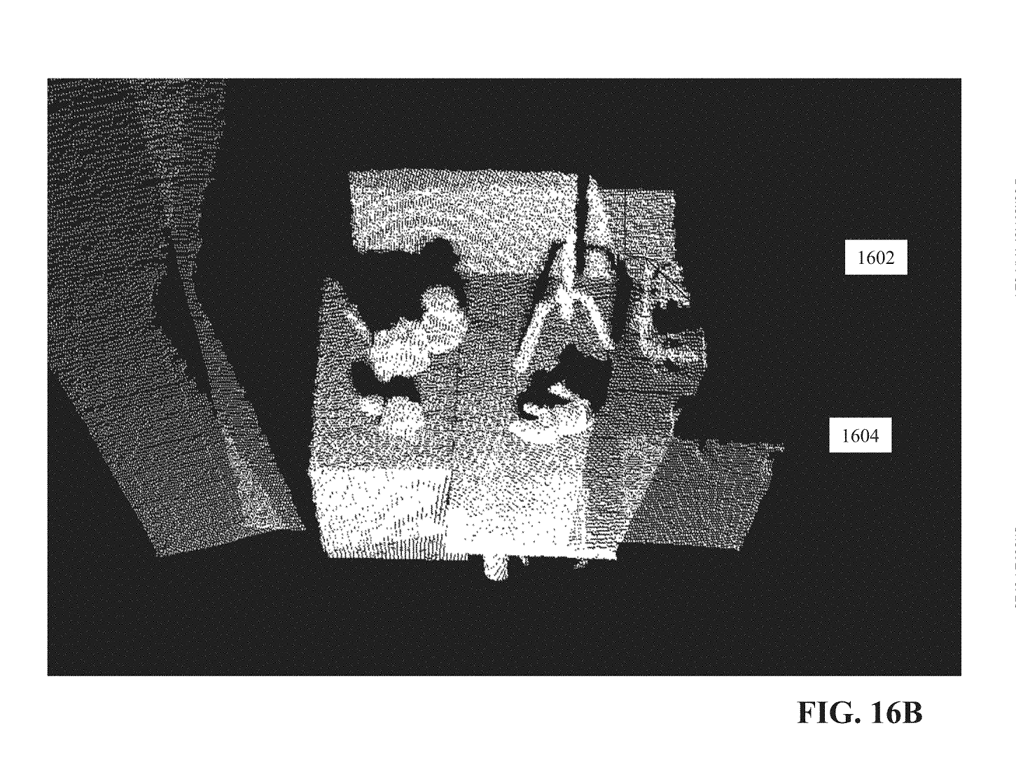

FIG. 16A depicts the initial position of the latest inserted key frame 1602 and the initial position of the matched key frame 1604 from the mapping database 208 in the global coordinate system. As shown in FIG. 16A, the initial positions are quite far apart. FIG. 16B depicts the positions of the latest inserted key frame 1602 and the matched key frame 1604 after 3D rigid transformation occurs. As shown, the positions are very close together.

Next, to close the loop (1406), the module 206 merges the latest inserted key frame with the matched key frame by merging the matched feature points and mapping points, and connects the key frames on one side of the loop to key frames on another side of the loop. The drifting error accumulated during the loop can be corrected through global bundle adjustment. Similar to local bundle adjustment, which optimizes poses and map points of the key frames by minimizing re-projection error, global bundle adjustment uses the same concepts, but instead the entire key frames and map points in the loop are involved in the process.

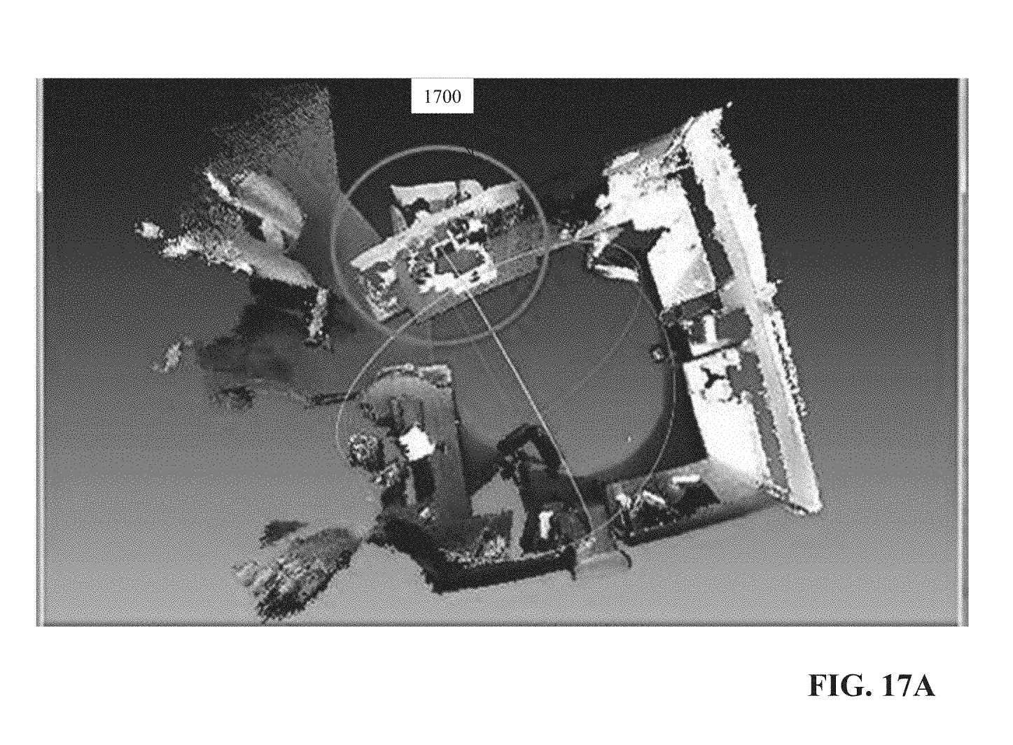

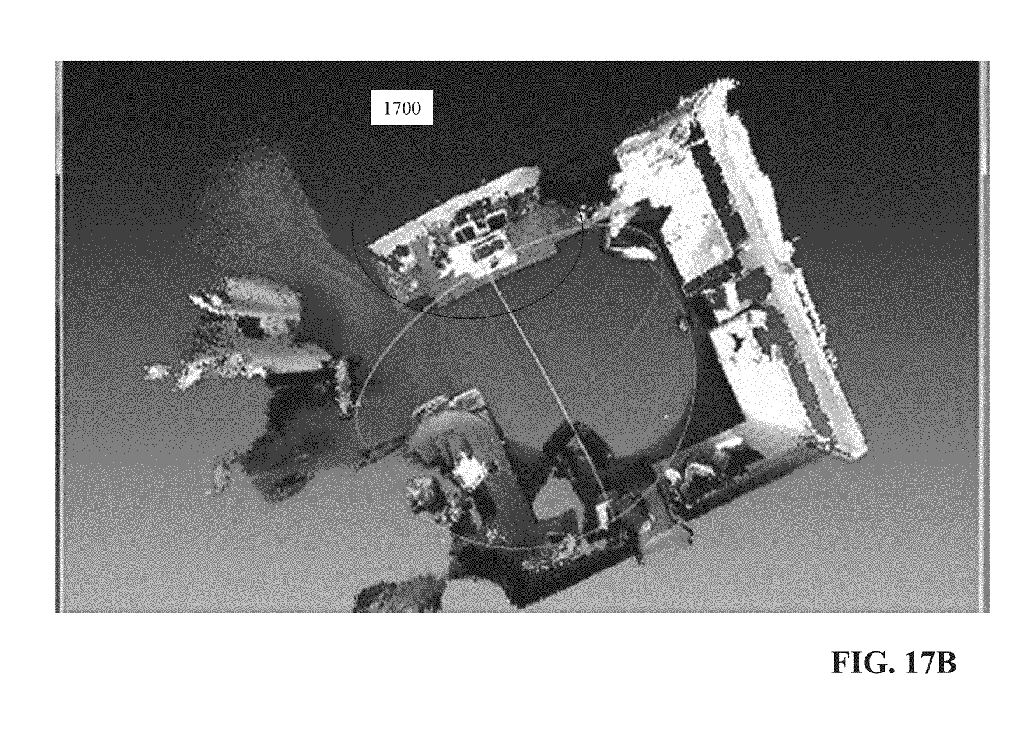

FIG. 17A depicts key frames without loop closure. As shown, there are significant drifting errors in the circle 1700. FIG. 17B depicts key frames after loop closure is completed. The drifting errors in circle 1700 no longer appear. Once the module 206 has completed the loop closure process, the module 206 updates the mapping database 208 with the latest inserted key frame.

It should be appreciated that the methods, systems, and techniques described herein are applicable to a wide variety of useful commercial and/or technical applications. Such applications can include:
Augmented Reality—to capture, track, and paint real-world objects from a scene for representation in a virtual environment;
3D Printing—real-time dynamic three-dimensional (3D) model reconstruction with occlusion or moving objects as described herein can be used to create and paint a 3D model easily by simply rotating the object by hand and/or via a manual device. The hand (or turntable), as well as other non-object points, are simply removed in the background while the surface of the object is constantly being updated with the most accurate points extracted from the scans. The methods and systems described herein can also be in conjunction with higher-resolution lasers or structured light scanners to track object scans in real-time to provide accurate tracking information for easy merging of higher-resolution scans.
Entertainment—For example, augmented or mixed reality applications can use real-time dynamic three-dimensional (3D) model reconstruction with occlusion or moving objects as described herein to dynamically create and paint 3D models of objects or features, which can then be used to super-impose virtual models on top of real-world objects. The methods and systems described herein can also be used for classification and identification of objects and features. The 3D models can also be imported into video games.
Parts Inspection—real-time dynamic three-dimensional (3D) model reconstruction with occlusion or moving objects as described herein can be used to create and paint a 3D model which can then be compared to a reference CAD model to be analyzed for any defects or size differences.
E-commerce/Social Media—real-time dynamic three-dimensional (3D) model reconstruction with occlusion or moving objects as described herein can be used to easily model humans or other real-world objects which are then imported into e-commerce or social media applications or websites.
Other applications—any application that requires 3D modeling or reconstruction can benefit from this reliable method of extracting just the relevant object points and removing points resulting from occlusion in the scene and/or a moving object in the scene.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the technology may be embodied in other specific forms without departing from the spirit or essential characteristics thereof. The foregoing embodiments are therefore to be considered in all respects illustrative rather than limiting of the technology described herein.

What is claimed is:

1. A system for tracking a pose of one or more objects represented in a scene, the system comprising:
a sensor that captures a plurality of scans of one or more objects in a scene, each scan comprising a color and depth frame;
a database that stores one or more key frames of the one or more objects in the scene, each key frame comprising a plurality of map points associated with the one or more objects;
a computing device that:
a) receives a first one of the plurality of scans from the sensor;
b) determines two-dimensional (2D) feature points of the one or more objects using the color and depth frame of the received scan;
c) retrieves a key frame from the database;
d) matches one or more of the 2D feature points with one or more of the map points in the key frame;
e) generate a current pose of the one or more objects in the color and depth frame using the matched 2D feature points;
f) insert the color and depth frame into the database as a new key frame, including the matched 2D feature points as map points for the new key frame; and
g) repeat steps a)-f) on each of the remaining scans, using the inserted new key frame for matching in step d);
wherein the computing device tracks the pose of the one or more objects in the scene across the plurality of scans.

2. The system of claim 1, further comprising generating a 3D model of the one or more objects in the scene using the tracked pose information.

3. The system of claim 1, wherein the step of inserting the color and depth frame into the database as a new key frame comprises:
converting the color and depth frame into a new key frame and converting the 2D feature points of the color and depth frame into map points of the new key frame;
fusing one or more map points of the new key frame that have valid depth information with similar map points of one or more neighbor key frames;
estimating a 3D position of one or more map points of the new key frame that do not have valid depth information;
refining the pose of the new key frame and the one or more neighbor key frames fused with the new key frame; and
storing the new key frame and associated map points into the database.

4. The system of claim 3, wherein converting the color and depth frame into a new key frame and converting the 2D feature points of the color and depth frame into map points of the new key frame comprises converting a 3D position of the one or more map points of the new key frame from a local coordinate system to a global coordinate system using the pose of the new key frame.

5. The system of claim 3, wherein the computing device correlates the new key frame with the one or more neighbor key frames based upon a number of map points shared between the new key frame and the one or more neighbor key frames.

6. The system of claim 3, wherein the step of fusing one or more map points of the new key frame that have valid depth information with similar map points of one or more neighbor key frames comprises:
projecting each map point from the one or more neighbor key frames to the new key frame;
identifying a map point with similar 2D features that is closest to a position of the projected map point; and
fusing the projected map point from the one or more neighbor key frames to the identified map point in the new key frame.

7. The system of claim 3, wherein the step of estimating a 3D position of one or more map points of the new key frame that do not have valid depth information comprises:
matching a map point of the new key frame that do not have valid depth information with a map point in each of two neighbor key frames; and
determining a 3D position of the map point of the new key frame using linear triangulation with the 3D position of the map points in the two neighbor key frames.

8. The system of claim 3, wherein the step of refining the pose of the new key frame and the one or more neighbor key frames fused with the new key frame is performed using local bundle adjustment.

9. The system of claim 3, wherein the computing device deletes redundant key frames and associated map points from the database.

10. The system of claim 1, wherein the computing device:
determines a similarity between the new key frame and one or more key frames stored in the database;
estimates a 3D rigid transformation between the new key frame and the one or more key frames stored in the database;
selects a key frame from the one or more key frames stored in the database based upon the 3D rigid transformation; and
merges the new key frame with the selected key frame to minimize drifting error.

11. The system of claim 10, wherein the step of determining a similarity between the new key frame and one or more key frames stored in the database comprises determining a number of matched features between the new key frame and one or more key frames stored in the database.

12. The system of claim 10, wherein the step of estimating a 3D rigid transformation between the new key frame and the one or more key frames stored in the database comprises:
selecting one or more pairs of matching features between the new key frame and the one or more key frames stored in the database;
determining a rotation and translation of each of the one or more pairs; and
selecting a pair of the one or more pairs with a maximum inlier ratio using the rotation and translation.

13. The system of claim 10, wherein the step of merging the new key frame with the selected key frame to minimize drifting error comprises:
merging one or more feature points in the new key frame with one or more feature points in the selected key frame; and
connecting the new key frame to the selected key frame using the merged feature points.

14. A computerized method of tracking a pose of one or more objects represented in a scene, the method comprising:
a) capturing, by a sensor, a plurality of scans of one or more objects in a scene, each scan comprising a color and depth frame;
b) receiving, by a computing device, a first one of the plurality of scans from the sensor;
c) determining, by the computing device, two-dimensional (2D) feature points of the one or more objects using the color and depth frame of the received scan;
d) retrieving, by the computing device, a key frame from a database that stores one or more key frames of the one or more objects in the scene, each key frame comprising a plurality of map points associated with the one or more objects;
e) matching, by the computing device, one or more of the 2D feature points with one or more of the map points in the key frame;
f) generating, by the computing device, a current pose of the one or more objects in the color and depth frame using the matched 2D feature points;
g) inserting, by the computing device, the color and depth frame into the database as a new key frame, including the matched 2D feature points as map points for the new key frame; and
h) repeating, by the computing device, steps b)-g) on each of the remaining scans, using the inserted new key frame for matching in step e);
wherein the server computing device tracks the pose of the one or more objects in the scene across the plurality of scans.

15. The method of claim 14, further comprising generating, by the computing device, a 3D model of the one or more objects in the scene using the tracked pose information.

16. The method of claim 14, wherein the step of inserting the color and depth frame into the database as a new key frame comprises:
converting the color and depth frame into a new key frame and converting the 2D feature points of the color and depth frame into map points of the new key frame;
fusing one or more map points of the new key frame that have valid depth information with similar map points of one or more neighbor key frames;
estimating a 3D position of one or more map points of the new key frame that do not have valid depth information;
refining the pose of the new key frame and the one or more neighbor key frames fused with the new key frame; and
storing the new key frame and associated map points into the database.

17. The method of claim 16, wherein converting the color and depth frame into a new key frame and converting the 2D feature points of the color and depth frame into map points of the new key frame comprises converting a 3D position of the one or more map points of the new key frame from a local coordinate system to a global coordinate system using the pose of the new key frame.

18. The method of claim 16, further comprising correlating the new key frame with the one or more neighbor key frames based upon a number of map points shared between the new key frame and the one or more neighbor key frames.

19. The method of claim 16, wherein the step of fusing one or more map points of the new key frame that have valid depth information with similar map points of one or more neighbor key frames comprises:
projecting each map point from the one or more neighbor key frames to the new key frame;
identifying a map point with similar 2D features that is closest to a position of the projected map point; and
fusing the projected map point from the one or more neighbor key frames to the identified map point in the new key frame.

20. The method of claim 16, wherein the step of estimating a 3D position of one or more map points of the new key frame that do not have valid depth information comprises:
matching a map point of the new key frame that do not have valid depth information with a map point in each of two neighbor key frames; and
determining a 3D position of the map point of the new key frame using linear triangulation with the 3D position of the map points in the two neighbor key frames.

21. The method of claim 16, wherein the step of refining the pose of the new key frame and the one or more neighbor key frames fused with the new key frame is performed using local bundle adjustment.

22. The method of claim 16, further comprising deleting redundant key frames and associated map points from the database.

23. The method of claim 14, further comprising:
determining a similarity between the new key frame and one or more key frames stored in the database;
estimating a 3D rigid transformation between the new key frame and the one or more key frames stored in the database;
selecting a key frame from the one or more key frames stored in the database based upon the 3D rigid transformation; and
merging the new key frame with the selected key frame to minimize drifting error.

24. The method of claim 23, wherein the step of determining a similarity between the new key frame and one or more key frames stored in the database comprises determining a number of matched features between the new key frame and one or more key frames stored in the database.

25. The method of claim 23, wherein the step of estimating a 3D rigid transformation between the new key frame and the one or more key frames stored in the database comprises:
selecting one or more pairs of matching features between the new key frame and the one or more key frames stored in the database;
determining a rotation and translation of each of the one or more pairs; and
selecting a pair of the one or more pairs with a maximum inlier ratio using the rotation and translation.

26. The method of claim 23, wherein the step of merging the new key frame with the selected key frame to minimize drifting error comprises:
merging one or more feature points in the new key frame with one or more feature points in the selected key frame; and
connecting the new key frame to the selected key frame using the merged feature points.
